(19) United States
(12) Patent Application Publication
(10) Pub. No.: US 2003/0053080 A1
(43) Pub. Date: Mar. 20, 2003

(54) Targeting device with four fixed reflective surfaces

(75) Inventors: Sajan Gianchandani, Paris (FR); Alexandre Leroy, Sannois (FR)

Correspondence Address: SCHNADER HARRISON SEGAL & LEWIS, LLP, 1600 MARKET STREET, SUITE 3600, PHILADELPHIA, PA, 19103

(73) Assignee: Egg Solution Optronics SA, Paris (FR)

(21) Appl. No.: 10/251,551

(22) Filed: Sep. 20, 2002

Related U.S. Application Data
(63) Continuation of application No. PCT/FR01/00878, filed on Mar. 22, 2001.

(30) Foreign Application Priority Data
Mar. 22, 2000 (FR) 00/03672

(51) Int. Cl. G01B 11/14

(52) U.S. Cl. 356/620

(57) ABSTRACT

A targeting device for determining the position of a target in space including at least four reflectors, each reflector having a concave conical surface, and an electromagnetic wave sensor associated with each of the reflectors. Axes longitudinally extending through the surfaces are substantially parallel, three of the surfaces are arranged substantially in a horizontal mean plane P such that respective axes of the three surfaces form in horizontal section a triangle and a fourth one of the surfaces is spaced from the three surfaces.

### RELATED APPLICATIONS

This application is a continuation of PCT/FR01/00878 filed Mar. 22, 2001 which claims benefit from French Application No. 00/03672 filed Mar. 22, 2000.

### FIELD OF THE INVENTION

This invention relates to the field of targeting and detector devices referred to as passive. More particularly, the invention relates to a targeting device enabling determination of the position of a target in space.

### BACKGROUND

Targeting devices are known in the art, such as U.S. Pat. No. 3,961,851, which pertains to a targeting system using three mobile video cameras to determine the position of a target in space. The major disadvantages of this device are: it is bulky, heavy, and ineffective in rapidly tracking targets because the mobile objectives must be moved very quickly with a high degree of precision.

It would, therefore, be advantageous to resolve the problems of the prior art by providing a fixed targeting device which does not require moving the objectives of the electromagnetic wave sensors to track a target in space.

### SUMMARY OF THE INVENTION

A targeting device for determining the position of a target in space comprising at least four reflectors, each reflector having a concave conical surface, and an electromagnetic wave sensor associated with each of the reflectors. Axes longitudinally extending through the surfaces are substantially parallel, three of the surfaces are arranged substantially in a horizontal mean plane P such that respective axes of the three surfaces form in horizontal section a triangle and a fourth one of the surfaces is spaced from the three surfaces.

### BRIEF DESCRIPTION OF THE DRAWINGS

A better understanding of the invention will be obtained from the description below presented in a purely explanatory manner for one mode of implementation of the invention with reference to the attached figures:

FIG. 1 is a perspective view of a device according to the invention,

FIG. 2 is a front view of the device of FIG. 1 and

FIG. 3 is a top view of the device of FIG. 1.

### DETAILED DESCRIPTION

It will be appreciated that the following description is intended to refer to specific embodiments of the invention selected for illustration in the drawings and is not intended to define or limit the invention, other than in the appended claims.

The invention is remarkable in its broadest sense in that it comprises four reflectors each associated respectively with an electromagnetic wave sensor, the reflectors each being provided respectively with a concave conical surface and arranged such that the axes respectively of the four conical surfaces are substantially parallel and substantially vertical, three conical surfaces being arranged in the same substantially horizontal mean plane in a manner such that their respective axes in horizontal section form a triangle and the fourth conical surface being arranged above the other three surfaces.

A “cone” as used herein is a regular surface, the generatrix of which passes through a fixed point, the vertex. A “concave cone” as used herein is a cone, the generatrix of which has a curvature in the direction of the axis of the cone.

According to variants of the invention, the conical surfaces are generated by an essentially parabolic generatrix or by a generatrix comprising essentially an arc of a circle or by an essentially elliptical generatrix.

The three conical surfaces are preferably arranged in the same horizontal mean plane in a manner such that their respective axes form in horizontal section an equilateral triangle.

The reflectors preferably each have a concave conical form which comprises a vertex, the vertices being oriented toward the electromagnetic wave sensors. The reflectors are preferably each arranged in a protective housing. The protective housings each have at least one window which is at least partially transparent over at least the entire height of at least part of the conical surfaces.

Two objectives on the same horizontal plane allow determination of the position of a target on this plane. The third objective is only present to compensate for the blind angle presence for the two other objectives.

The fourth objective, arranged on a different horizontal plane from the three others, enables localization by altitude.

The invention advantageously enables implementation of a compact, light and easy to handle targeting device. The invention also advantageously makes it possible to reduce the delays in calculation of position and to obtain targeting data extremely quickly.

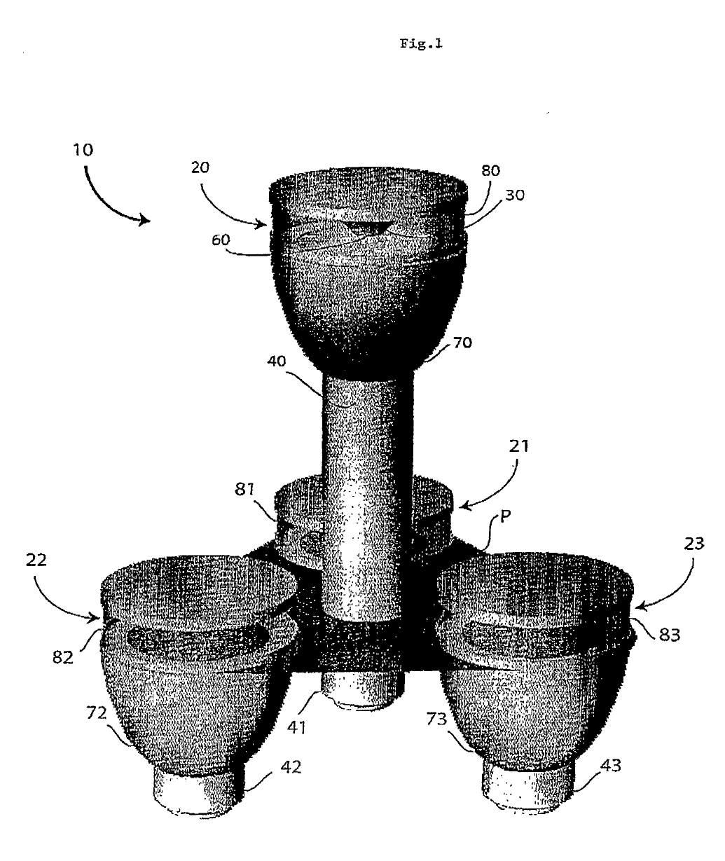

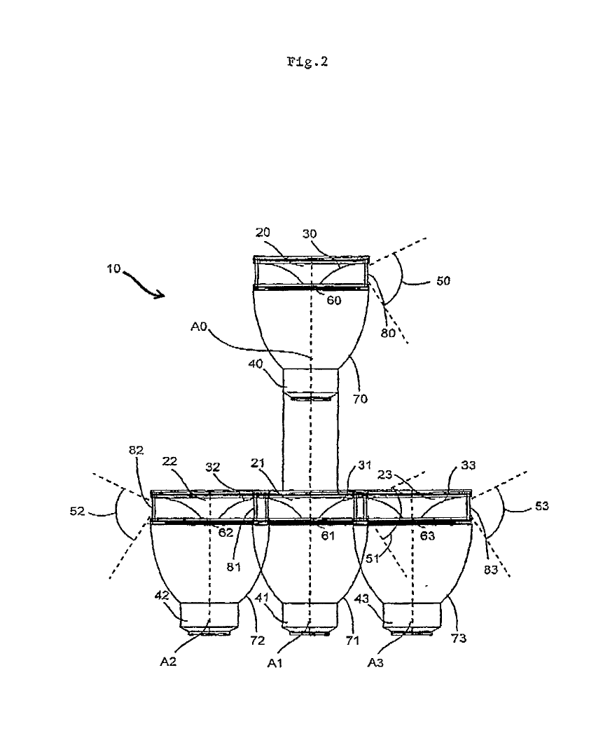

Turning now to the drawings, the targeting device (10) according to the invention, as illustrated particularly in FIGS. 1 and 2, is a device enabling determination of the position of a target in space, and comprises at least one reflector (20) provided with an exterior surface (30) which is at least partially reflective, associated with an electromagnetic wave sensor (40).

The targeting device (10) according to the invention is characterized in that it comprises four reflectors (20, 21, 22, 23) each associated respectively with an electromagnetic wave sensor (40, 41, 42, 43), reflectors (20, 21, 22, 23) each being provided respectively with a concave conical surface (30, 31, 32, 33) and being arranged such that the axes (A0, A1, A2, A3), respectively, of the four conical surfaces (30, 31, 32, 33) are substantially parallel and substantially vertical, three conical surfaces (31, 32, 33) being arranged in the same horizontal mean plane P such that their respective axes (A1, A2, A3) in horizontal section form a triangle and the fourth conical surface (30) being spaced or arranged apart from, most preferably above, the other three conical surfaces.

The three conical surfaces (31, 32, 33) are arranged in the same horizontal mean plane P, preferably in a manner such that their respective axes (A1, A2, A3) form in horizontal section an equilateral triangle.

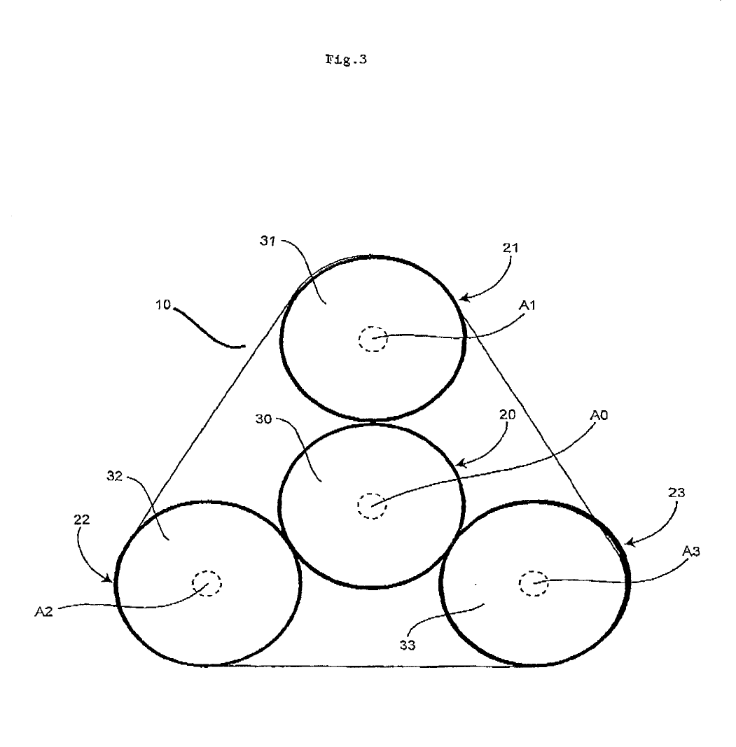

The positioning of the fourth conical surface (30) is of minor importance. It can be arranged such that its axis (A0) is inscribed in the triangle formed by the axes (A1, A2, A3), respectively, of the three conical surfaces (31, 32, 33) as illustrated in FIG. 3.

The reflectors (20, 21, 22, 23) are preferably identical and are positioned, respectively, in the optical axis of the electromagnetic wave sensors (40, 41, 42, 43).

According to variants of the invention, the conical surfaces (30, 31, 32, 33) are generated by an essentially parabolic generatrix or by a generatrix comprising essentially an arc of a circle or by an essentially elliptical generatrix, depending on the desired position determination characteristics. Thus, the section viewed from below each surface is a circle or an ellipse.

By means of the concave conical surfaces (30, 31, 32, 33), the departure point of the angle of vision of the proximal end of each reflector is offset towards its distal end. Thus, the conical surfaces (30, 31, 32, 33) do not reflect the observer or the electromagnetic wave sensor (40, 41, 42, 43) positioned at the place of the observer. The electromagnetic wave sensors (40, 41, 42, 43) are then outside of the visual fields (50, 51, 52, 53) as illustrated in FIG. 2 and the conical surfaces (30, 31, 32, 33) can be positioned in a protective device also located, respectively, outside of the visual fields (50, 51, 52, 53).

The reflectors (20, 21, 22, 23) preferably each have a conical form that comprises a vertex (60, 61, 62, 63), the vertices (60, 61, 62, 63) being oriented towards the electromagnetic wave sensors (40, 41, 42, 43) to minimize luminosity losses.

The reflectors (20, 21, 22, 23) are each arranged in a protective housing (70, 71, 72, 73) each having at least one window (80, 81, 82, 93) at least partially transparent over at least the entire height of at least a part of the conical surfaces (30, 31, 32, 33).

It is possible to envisage that there are no reflective surfaces nor windows in the blind angles of the reflectors caused by the presence of the other reflectors.

The induced visual fields (50, 51, 52, 53) are of 360° in the horizontal field and about 90° in the vertical plane. The values of the fields of vision are essentially defined by the curvature of the reflective surfaces and the vertical position of the fourth reflective surface in relation to the first three reflective surfaces.

A common support is preferably also provided at the lower end of the device to ensure that the positions of the surfaces are fixed in relation to each other.

The device, thus, makes it possible to calculate extremely quickly the position (three coordinates in space) of a target with sufficient data processing even when the target is very far away (several tens of meters).

For determining the coordinates along the horizontal, two reflectors located on the same plane P, each associated with a sensor are sufficient. The vertical coordinates are then determined by the fourth reflective surface located in another plane, but the axis of which is parallel to the axis of the other three reflective surfaces. The data possibly provided by the third reflective surface located in plane P are used to confirm the data obtained by the first two reflective surfaces.

This invention is described above as non-limiting example. It is understood that one of ordinary skill in the art can implement different variants without extending beyond the scope of the invention as defined in the appended claims.

1. A targeting device enabling determination of the position of a target in space, of the type comprising at least one reflector provided with an exterior surface which is at least partially reflective, associated with an electromagnetic wave sensor, characterized in that it comprises four reflector means each associated respectively with an electromagnetic wave sensor, said reflector means each being provided respectively with a concave conical surface and being arranged such that the axes respectively of the four surfaces are parallel and vertical, three surfaces being arranged in the same horizontal mean plane P such that their respective axes form in horizontal section a triangle and the fourth surface being arranged above the other three surfaces.

2. The device according to claim 1, characterized in that the three conical surfaces are arranged in the same horizontal mean plane P such that their respective axes form in horizontal section an equilateral triangle.

3. The device according to claim 1, characterized in that each of said conical surfaces is generated by an essentially parabolic generatrix.

4. The device according to claim 1, characterized in that each of said conical surfaces is generated by a generatrix essentially comprising the arc of a circle.

5. The device according to claim 1, characterized in that each of said conical surfaces is generated by an essentially elliptical generatrix.

6. The device according to claim 1, characterized in that each of said reflector means has a conical form that comprises a vertex, said vertices being oriented towards said electromagnetic wave sensors.

7. The device according to claim 1, characterized in that said reflector means are each arranged in a protective housing each having at least one window at least partially transparent over at least one entire height of at least a part of said conical surfaces.

8. A targeting device for determining the position of a target in space comprising:
at least four reflectors, each reflector having a concave conical surface; and
an electromagnetic wave sensor associated with each of the reflectors;
wherein axes longitudinally extending through the surfaces are substantially parallel, three of the surfaces are arranged substantially in a horizontal mean plane P such that respective axes of the three surfaces form in horizontal section a triangle and a fourth one of the surfaces is spaced from the three surfaces.

9. The device according to claim 8, wherein the triangle is an equilateral triangle.

10. The device according to claim 8, wherein each of the surfaces is generated by an essentially parabolic generatrix.

11. The device according to claim 8, wherein each of the surfaces is generated by a generatrix essentially comprising an arc of a circle.

12. The device according to claim 8, wherein each of the surfaces is generated by an essentially elliptical generatrix.

13. The device according to claim 8, wherein each of the reflectors has a conical form that comprises a vertex, the vertices being oriented towards the electromagnetic wave sensors.

14. The device according to claim 8, wherein the reflectors are each arranged in a protective housing, each housing having at least one window at least partially transparent over at least one entire height of at least a part of the surfaces.

15. The device accordingly to claim 8, wherein the fourth surface is spaced above the three surfaces.

16. The device according to claim 8, wherein the axes are substantially vertically oriented.
